(19) United States
(12) Patent Application Publication
(10) Pub. No.: US 2021/0192761 A1
(43) Pub. Date: Jun. 24, 2021

(54) IMAGE DEPTH ESTIMATION METHOD AND DEVICE, READABLE STORAGE MEDIUM, AND ELECTRONIC APPARATUS

(71) Applicant: SZ DJI TECHNOLOGY CO., LTD., Shenzhen (CN)

(72) Inventors: You ZHOU, Shenzhen (CN); Zhenyu ZHU, Shenzhen (CN); Shibo WANG, Shenzhen (CN)

(21) Appl. No.: 17/173,162

(22) Filed: Feb. 10, 2021

Related U.S. Application Data
(63) Continuation of application No. PCT/CN2018/101821, filed on Aug. 22, 2018.

(51) Int. Cl. G06T 7/50; G06T 7/90; G06K 9/46

(52) U.S. Cl. CPC G06T 7/50; G06K 9/4652; G06T 7/90

(57) ABSTRACT

An image depth estimation method includes detecting a weak texture area of a target image, calculating depths of feature points of the weak texture area, performing fitting based on the feature points to obtain a depth plane, and calculating depths of pixel points of the weak texture area based on the depth plane. The depths of feature points of the weak texture area are calculated according to coordinates of the feature points of the weak texture area in the target image and in a reference image, and a camera attitude change of one or more camera devices between capturing the target image and capturing the reference image.

### CROSS-REFERENCE TO RELATED APPLICATION

This application is a continuation of International Application No. PCT/CN2018/101821, filed Aug. 22, 2018, the entire content of which is incorporated herein by reference.

### TECHNICAL FIELD

The present disclosure generally relates to the image processing technology field and, more particularly, to an image depth estimation method and device, a readable storage medium, and an electronic apparatus.

### BACKGROUND

In image processing, a depth of an image is calculated according to matching between feature points of a plurality of images to determine information of distance and relative position of a target object in the images. In some scenes, such as a weak texture scene, since feature points are too few, matching precision is poor, which affects accuracy of depth calculation, and further causes false operation of a control apparatus using the result of the depth calculation.

### SUMMARY

Embodiments of the present disclosure provide an image depth estimation method. The method includes detecting a weak texture area of a target image, calculating depths of feature points of the weak texture area, performing fitting based on the feature points to obtain a depth plane, and calculating depths of pixel points of the weak texture area based on the depth plane. The depths of feature points of the weak texture area are calculated according to coordinates of the feature points of the weak texture area in the target image and in a reference image, and a camera attitude change of one or more camera devices between capturing the target image and capturing the reference image.

Embodiments of the present disclosure provide an image depth estimation device including a processor and a memory. The memory stores instructions that, when executed by the processor, cause the processor to detect a weak texture area of a target image, calculate depths of feature points of the weak texture area, perform fitting based on the feature points to obtain a depth plane, and calculate depths of pixel points of the weak texture area based on the depth plane. The depths of feature points of the weak texture area are calculated according to coordinates of the feature points of the weak texture area in the target image and in a reference image, and a camera attitude change of one or more camera devices between capturing the target image and capturing the reference image.

### BRIEF DESCRIPTION OF THE DRAWINGS

FIG. 1 is a schematic flowchart of an image depth estimation method according to some embodiments of the present disclosure.

FIG. 2 is a schematic structural diagram of an image depth estimation device according to some embodiments of the present disclosure.

FIG. 3 is a schematic structural diagram of another image depth estimation device according to some embodiments of the present disclosure.

FIG. 4 is a schematic structural diagram of an electronic apparatus according to some embodiments of the present disclosure.

### DETAILED DESCRIPTION OF THE EMBODIMENTS

Technical solutions consistent with embodiments of the present disclosure are described in detail in connection with the accompanying drawings consistent with embodiments of the present disclosure. Described embodiments are merely some embodiments of the present disclosure but not all embodiments. All other embodiments obtained by those of ordinary skill in the art without creative efforts are within the scope of the present disclosure.

In connection with the accompanying drawings, an image depth estimation method and device provided by embodiments of the present disclosure are described in detail. When there is no conflict, embodiments and features of embodiments may be combined with each other.

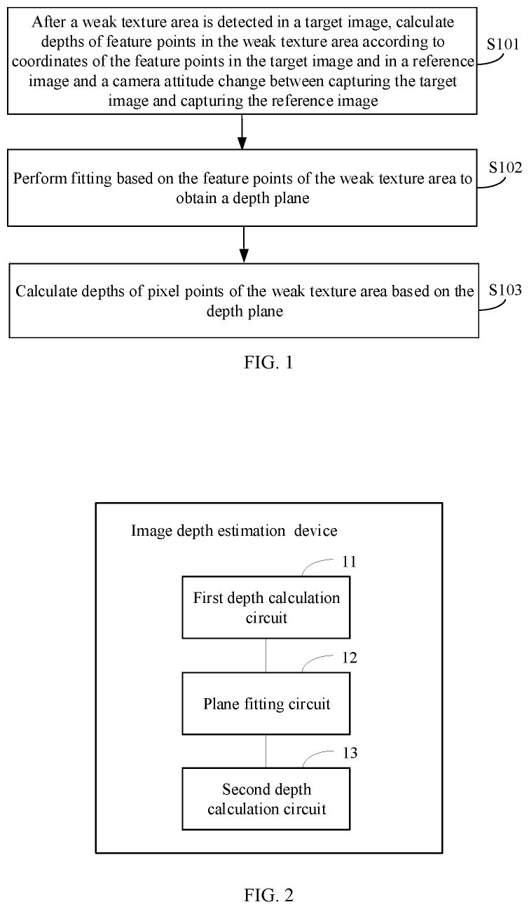

As shown in FIG. 1, embodiments of the present disclosure provide an image depth estimation method. The method can be applied to an electronic apparatus having an image processing function, for example, an unmanned vehicle, an automatic unmanned aerial vehicle (UAV), virtual reality (VR)/augmented reality (AR) glasses, a cell phone with dual cameras, etc. The method includes the following processes.

At S101, after a weak texture area is detected in a target image, depths of feature points in the weak texture area are calculated according to coordinates of the feature points in the target image and in a reference image and a camera attitude change between capturing the target image and capturing the reference image.

The target image and the reference image may include two images captured by the same camera device at different moments or two images captured by two camera devices having different view angles at a same moment. The camera attitude change refers to a change of an attitude of the same camera device when capturing the two images at the different moments or a difference between attitudes of the two camera devices when capturing the two images at the same moment.

For example, in a binocular vision system, formula (1) may be used to calculate the depth of a feature point of the weak texture area.

$$Z = f \frac{T}{d} \qquad ( 1 )$$

where Z denotes the depth of the feature point of the weak texture area, f denotes a focal length of the two camera devices of the binocular vision system, T denotes a distance between the two camera devices, which is also referred to as a baseline, and d denotes a disparity value of the feature point of the weak texture area in the target image and the reference image. The disparity value may be calculated according to the coordinates of the feature point of the weak texture area in the target image and the reference image.

In the binocular vision system, the target image and the reference image may be obtained by two vision sensors, respectively. The camera attitude change between capturing the target image and capturing the reference image may include an angle deviation and/or a distance deviation between the two vision sensors.

If the target image and the reference image are obtained by the same camera device at different moments, the camera attitude change between capturing the target image and capturing the reference image may include the angle deviation and/or the distance deviation between a moment when the target image is captured and a moment when the reference image is captured.

At S102, fitting is performed based on the feature points of the weak texture area to obtain a depth plane.

At S103, depths of pixel points of the weak texture area are calculated based on the depth plane.

In some embodiments, before determining that the weak texture area is detected in the target image, the image depth estimation method may include determining a connected area of the target image, extracting feature points of the connected area, and comparing a quantity M of the feature points of the connected area to a predetermined threshold N^{th}. A connected area subjected to the determination is also referred to as a “candidate connected area,” and a feature point of the connected area is also referred to as a “candidate feature point.” If M is smaller than N^{th}, the connected area may be considered an area with no texture. Otherwise, i.e., if M equals or is greater than N^{th}, the connected area may be considered a weak texture area.

In some embodiments, extracting the feature points may include performing extraction by using a corner detection algorithm. The corner detection algorithm may include feature points from accelerated segment test (FAST), smallest univalue segment assimilating nucleus (SUSAN), Harris operator, etc.

Extraction of the feature points using Harris operator is described below as an example.

First, matrix A is defined according to formula (2). Matrix A is a structure tensor.

$$A = {\sum }_{u} {\sum }_{v} w ( u , v ) [ \begin{matrix}{∇}_{x}^{2} & {∇}_{x} {∇}_{y} \\ {∇}_{x} {∇}_{y} & {∇}_{y}^{2}\end{matrix} ] = [ \begin{matrix}〈 {∇}_{x}^{2} 〉 & 〈 {∇}_{x} {∇}_{y} 〉 \\ 〈 {∇}_{x} {∇}_{y} 〉 & 〈 {∇}_{y}^{2} 〉\end{matrix} ] \qquad ( 2 )$$

where, ∇ₓ and ∇_{y} denote gradient information of a point of the connected area of the target image in x and y directions, respectively.

Then, a corner response function Mc is defined according to formula (3).

M_{c}=λ₁λ₂−k(λ₁+λ₂)²=det(A)−k*trace²(A) (3)

where, λ₁ and λ₂ denote feature values of matrix A, det(A) denotes a determinant of matrix A, trace(A) denotes a trace of matrix A, and k denotes a tunable sensitivity parameter.

Then, Mc may be compared to a predetermined threshold Mₜₕ. If Mc is greater than Mₜₕ, the point may be determined to be a feature point.

In some embodiments, determining the connected area of the target image may include detecting an edge of the target image using an edge detection algorithm and determining the connected area of the target image based on the detected edge of the target image.

The edge detection algorithm may include Sobel operator, Canny operator, etc.

In some embodiments, determining the connected area of the target image based on the detected edge of the target image may include performing filling on the target image using Flood fill algorithm based on the detected edge of the target image. The area filled into a block may be considered the connected area of the target image.

In some embodiments, another method may be used to detect the weak texture area of the target image, which is not limited by embodiments of the present disclosure.

In some embodiments, in process S102, performing fitting based on the feature points of the weak texture area to obtain the depth plane may include filtering out abnormal points among the feature points of the weak texture area using random sample consensus (RANSAC) algorithm to obtain reliable points among the feature points of the weak texture area and performing fitting based on the reliable points of the weak texture area to obtain the depth plane.

A process of filtering out the abnormal points of the feature points of the weak texture area may not be performed, which is not limited by embodiments of the present disclosure.

In some embodiments, in process S102, performing fitting based on the feature points of the weak texture area to obtain the depth plane may include determining a fitted plane according to the feature points of the weak texture area, calculating color deviations and/or distances between the feature points of the weak texture area and predetermined points of the fitted plane, and, if the color deviations and/or the distances between the feature points and the predetermined points satisfy a predetermined condition, determining the fitted plane to be the depth plane.

In some embodiments, the predetermined points of the fitted plane, for example, may include a center point of the fitted plane.

In some embodiments, determining the fitted plane according to the feature points of the weak texture area may include calculating 3D information of the feature points of the weak texture area according to pixel coordinates and depths of the feature points of the weak texture area, and determining the fitted plane based on the 3D information of the feature points of the weak texture area.

For example, the 3D information of a feature point of the weak texture area may be calculated by using formula (4).

$$[ \begin{matrix}x \\ y \\ z\end{matrix} ] = {K}^{- 1} ( Z * [ \begin{matrix}u \\ v \\ 1\end{matrix} ] ) \qquad ( 4 )$$

where, [x,y,z]^{T} denotes the 3D information of the feature point of the weak texture area, Z denotes the depth of the feature point of the weak texture area, [u,v,l]^{T} denotes the pixel coordinates of the feature point of the weak texture area, and K denotes an intrinsic parameter of the camera device. K may be determined before the camera device leaves the factory and may be calculated using formula (5).

$$K = [ \begin{matrix}{α}_{x} & γ & {u}_{0} \\ 0 & {α}_{y} & {v}_{0} \\ 0 & 0 & 1\end{matrix} ] \qquad ( 5 )$$

where, aₓ=fmₓ, a_{y}fm_{y}, f denotes a focal length, mₓ and m_{y} denote scale factors (representing number of pixels in a unit distance) in the x and y directions, respectively, γ denotes a skew parameter between the x-axis and y-axis, and u₀ and v₀ denote a location of principal point (i.e., coordinates of the principal point).

In some embodiments, determining the fitted plane as the depth plane if the color deviations and/or the distances between the feature points and the predetermined points satisfy the predetermined condition may include calculating a weighted sum of the color deviations and/or distances between the feature points and the predetermined points and, if the weighted sum is smaller than or equal to a predetermined value, determining the fitted plane as the depth plane.

In some embodiments, the weight of any one of the feature points may be determined according to the color deviation between the feature point and the predetermined point or according to a distance between the feature point and the predetermined point.

In some embodiments, to cause the calculated depth information to be more accurate and smooth, determining the fitted plane as the depth plane if the color deviations and/or the distances between the feature points and the predetermined points satisfy the predetermined condition may further include, if the weighted sum is greater than the predetermined value, dividing the weak texture area into a plurality of sub-areas, and performing fitting on the sub-areas to obtain depth planes of the sub-areas.

In some embodiments, if the fitted depth plane of a sub-areas still does not satisfy the requirement, the sub-area may be further divided.

In some embodiments, in process S103, calculating the depths of the pixel points of the weak texture area based on the depth plane may include using the depths of the points of the depth plane as the depths of the corresponding points of the area that the depth plane is generated for. The area that the depth plane is generated for may include the whole weak texture area or a plurality of sub-areas, which may be determined according to the situation when the depth plane is fitted.

In some embodiments, in process S103, calculating the depths of the pixel points of the weak texture area based on the depth plane may further include performing optimization on the depths of the pixel points using a global or semi-global optimization algorithm.

In some embodiments, the image depth estimation method may further include matching the pixels of the target image and the reference image to verify the depth calculation.

In some embodiments, matching the pixels of the target image and the reference image may include mapping the pixel points of the target image into the reference image according to the camera attitude change between capturing the target image and capturing the reference image, calculating the corresponding pixel information according to the mapping points of the reference image, and comparing the pixel information corresponding to the mapping points of the reference image and the pixel information of the pixel points of the target image.

In some embodiments, mapping the pixel points of the target image into the reference image according to the camera attitude change between capturing the target image and capturing the reference image the reference image may include selecting a specific or any point of the target image as the target point, for example, using a randomly selected point as the target point or selecting a feature point, e.g., an inflection point, of the target image as the target point, obtaining the pixel coordinate and the depth of the target point, determining the 3D coordinate of the target point according to the pixel coordinate and the depth of the target point and the parameter of the camera device, calculating the 3D coordinate of the target point mapped onto the reference image according to the camera attitude change between capturing the target image and capturing the reference image the reference image, and obtain the pixel coordinate of the mapping point of the reference image according to the 3D coordinate of the target point mapped onto the reference image and the parameter of the camera device.

For example, the pixel coordinate of the target point is q, the depth of the target point is Z, and the parameter of the camera device is K in formula (4). Thus, the 3D coordinate of the target point may be determined to be Z·K⁻¹q according to q, Z, and K.

Assume that the camera attitude change between capturing the target image and capturing the reference image the reference image may be represented by a rotation matrix R and a translation vector T, that is, the angle deviation and/or the distance. Thus, the 3D coordinate of the target point mapped onto the reference image may be calculated to be R(Z·K⁻¹q)+T.

Then, the pixel coordinate q′ of the mapping point in the reference image may be obtained to be K(R(Z·K⁻¹q)+T) according to the 3D coordinate R(Z·K⁻¹q)+T of the target point mapped to the reference image and the parameter K of the camera device.

In some embodiments, calculating the corresponding pixel information according to the mapping points of the reference image may include calculating the pixel information of the pixel where the mapping point is in the reference image through the interpolation method (e.g., bilinear interpolation method) according to the pixel coordinate of the mapping point of the reference image.

The coordinate of a selected point of the target image may include a decimal value after the selected point is mapped onto the reference image, and the coordinate of a pixel generally includes an integer value. Thus, the integer value of the coordinate of the pixel in the reference image corresponding to the mapping point and other related information such as color may be calculated by the interpolation method, that is, the pixel information of the pixel where the mapping point is.

The pixel information may include color brightness information.

In the method, the pixel coordinate of the mapping point of the reference image may include a decimal. However, the coordinate of the pixel point of the reference image may not include a decimal. Thus, the pixel information corresponding to the mapping point of the reference image may be obtained by the interpolation method using the pixel information of the pixel point neighboring to the mapping point.

In some embodiments, comparing the pixel information corresponding to the mapping point of the reference image and the pixel information of the pixel point of the target image may include calculating the color brightness information of the corresponding pixel according to the mapping point of the reference image to be compared to the color brightness information of the target point of the target image.

In some embodiments, comparing the pixel information corresponding to the mapping point of the reference image to the pixel information of the pixel point of the target image may further include, if the color brightness information deviation between the mapping point and the target point is smaller than or equal to the predetermined value, determining that the depth of the pixel point satisfies a requirement.

For example, the color brightness information of the mapping point of the reference image is I_{q}, the color brightness information of the target point of the target image is I_{q}′, whether the calculated depth of the pixel point satisfies the requirement is determined according to formula (6).

∥I_{q}−I_{q}^{′}∥₂≤Iₜₕ (6)

where, Iₜₕ denotes a predetermined value, which may be set according to the actual needs, and ∥·∥₂ represents a second-order norm. An absolute value of the difference between the color brightness information of the mapping point of the reference image and the color brightness information of the target point of the target image may be used to determine whether the depth of the pixel point satisfies the requirement.

Based on a same concept, as shown in FIG. 2, embodiments of the present disclosure provide an image depth estimation device, including a first depth calculation circuit 11, a plane fitting circuit 12, and a second depth calculation circuit 13. The image depth calculation device may include a chip having functional circuits. The first depth calculation circuit 11, the plane fitting circuit 12, and the second depth calculation circuit 13 may include three individual circuits or circuits that share some common part(s).

The first depth calculation circuit 11 may be configured to, after detecting the weak texture area in the target image, according to the coordinates of the feature points of the weak texture area in the target image and the reference image and the camera attitude change between capturing the target image and capturing the reference image the reference image, calculate the depths of the feature points of the weak texture area.

The plane fitting circuit 12 may be configured to perform fitting based on the feature points of the weak texture area to obtain the depth plane.

The second depth calculation circuit 13 may be configured to calculate the depths of the pixels of the weak texture area based on the depth plane.

In some embodiments, the first depth calculation circuit 11 may be configured to determine the connected area of the target image, extract the feature points of the connected area, and compare a quantity M of the feature points of the connected area to the predetermined threshold Nₜₕ. If M is smaller than Nₜₕ, the connected area may be considered the area with no texture. Otherwise, i.e., if M equals or is greater than Nₜₕ, the connected area may be considered the weak texture area.

In some embodiments, the first depth calculation circuit 11 may be configured to detect the edge of the target image using the edge detection algorithm and determine the connected area of the target image based on the detected edge of the target image.

In some embodiments, the plane fitting circuit 12 may be configured to filter out abnormal points among the feature points of the weak texture area using RANSAC algorithm to obtain the reliable points among the feature points of the weak texture area and perform fitting based on the reliable points of the weak texture area to obtain the depth plane.

In some embodiments, the plane fitting circuit 12 may be configured to determine the fitted plane according to the feature points of the weak texture area, calculate the color deviations and/or the distances between the feature points of the weak texture area and predetermined points of the fitted plane, and if the color deviations and/or the distances between the feature points and the predetermined points satisfy the predetermined condition, determine the fitted plane to be the depth plane.

In some embodiments, the predetermined point of the fitted plane, for example, may include the center point of the fitted plane.

In some embodiments, the plane fitting circuit 12 may be configured to calculate the 3D information of the feature points of the weak texture area according to the pixel coordinates and depths of the feature points of the weak texture area and determine the fitted plane based on the 3D information of the feature points of the weak texture area.

In some embodiments, the plane fitting circuit 12 may be configured to calculate the weighted sum of the color deviations and/or distances between the feature points and the predetermined points and, if the weighted sum is smaller than or equal to a predetermined value, determine the fitted plane as the depth plane.

In some embodiments, the plane fitting circuit 12 may be configured to, if the weighted sum is greater than the predetermined value, divide the weak texture area into the plurality of sub-areas, and perform fitting on the sub-areas to obtain the depth planes.

In some embodiments, the second depth calculation circuit 13 may be configured to use the depths of the points of the depth plane as the depths of the corresponding points of the area that the depth plane is generated for.

In some embodiments, the second depth calculation circuit 13 may be configured to perform optimization on the depths of the pixels points using a global or semi-global optimization algorithm.

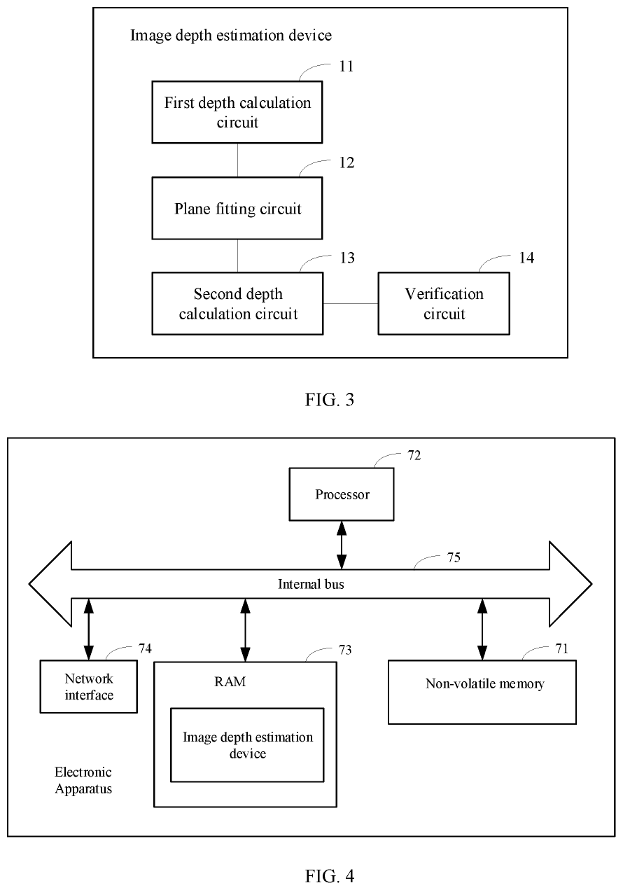

In some embodiments, as shown in FIG. 3, the image depth estimation device further includes a verification circuit 14. The verification circuit 14 may be configured to perform matching on the pixels of the target image and the reference image to perform verification on the depth calculation. The verification circuit 14, the first depth calculation circuit 11, the plane fitting circuit 12, and the second depth calculation circuit 13 may include several individual circuits or circuits that share a common relationship with each other.

In some embodiments, the verification circuit 14 may be configured to map the pixel points of the target image into the reference image according to the camera attitude change between capturing the target image and capturing the reference image the reference image, calculate the corresponding pixel information according to the mapping points of the reference image, and compare the pixel information corresponding to the mapping points of the reference image and the pixel information of the pixel points of the target image.

In some embodiments, the verification circuit 14 may be configured to select the specific or any point of the target image as the target point, obtain the pixel coordinate and the depth of the target point, determine the 3D coordinate of the target point according to the pixel coordinate and the depth of the target point and the parameter of the camera device, calculate the 3D coordinate of the target point mapped onto the reference image according to the camera attitude change between capturing the target image and capturing the reference image the reference image, and obtain the pixel coordinate of the mapping point of the reference image according to the 3D coordinate of the target point mapped onto the reference image and the parameter of the camera device.

In some embodiments, the verification circuit 14 may be configured to calculate the pixel information of the pixel of the reference image where the mapping point is by the interpolation method according to the pixel coordinate of the mapping point of the reference image.

In some embodiments, the verification circuit 14 may be configured to calculate the color brightness information of the pixel corresponding to the mapping point of the reference image to be compared to the color brightness information of the target point of the target image.

In some embodiments, the verification circuit 14 may be configured to, if the color brightness information deviation between the mapping point and the target point is smaller than or equal to the predetermined value, determine that the calculated depths of the pixel point satisfies the requirement.

For specific implementation processes of the functions and roles of the circuits in the device, reference is made to the implementation process of the corresponding steps in the above-mentioned method for details, which is not be repeated here.

Since device embodiments basically correspond to method embodiments, for relevant parts, reference may be made to a part of the description of method embodiments. The above-described device embodiments are merely illustrative. The units described as separate components may or may not be physically separated. The components displayed as units may or may not be physical units, that is, the units may be located in one place or distributed to a plurality of network units. Some or all of the circuits may be selected according to actual needs to realize the purpose of the solution of the present disclosure. Those of ordinary skill in the art may understand and implement the purpose of the solution of the present disclosure without creative effort.

Based on the same concept, embodiments of the present disclosure further provide a computer-readable storage medium storing a computer program. When the computer program is executed, the processes of the image depth estimation method may be implemented.

In some embodiments, the storage medium may include a storage device.

Based on the same concept. As shown in FIG. 4, embodiments of the present disclosure provide an electronic apparatus including a storage device 71 (e.g., a non-volatile memory), a processor 72, and a computer program that is stored in the storage device 71 and executed by the processor 72. The computer program, when executed by the processor 72, may cause the processor 72 to implement the processes of the image depth estimation method, which is similar to the image depth estimation device. The processor may also be configured to process another data or calculation.

The electronic apparatus may include a camera device, such as a camera, and a gimbal or a UAV having a camera. The UAV may include a binocular vision sensor. In addition, the electronic apparatus may further include, for example, an unmanned vehicle, VR/AR glasses, a mobile terminal with dual cameras such as a cell phone with dual cameras, etc.

As shown in FIG. 4, the electronic apparatus further includes a random access memory (RAM) 73, a network interface 74, and an internal bus 75. In addition to these components, the electronic apparatus may further include another hardware, which is not repeated.

The image depth estimation device may be implemented by software. As a logical device, the image depth estimation device may be formed by the processor 72 of the electronic apparatus reading the computer program stored in the non-volatile memory into the RAM 73 for execution.

Embodiments of the subject and functional operations described in this specification may be implemented in tangible computer software or firmware, computer hardware including the structure disclosed in this specification and its structural equivalents, or one or more combination thereof. Embodiments of the subject described in this specification may be implemented as one or more computer programs, that is, codes that is executed by a data processing device on a tangible non-transitory program carrier or one or more modules of the computer program instructions that control the operation of the data processing device. Alternatively or additionally, the program instructions may be encoded on an artificially-generated propagated signal, such as a machine-generated electrical, optical, or electromagnetic signal. The signal is generated to encode and transmit information to a suitable receiver device to be executed by the data processing device. The computer storage medium may include a machine-readable storage device, a machine-readable storage substrate, a random or serial access memory device, or a combination of thereof.

The processing and logic flow described in this specification may be executed by one or more programmable computers executing one or more computer programs to perform corresponding functions by performing an operation according to input data and generating output. The processing and logic flow may also be executed by a dedicated logic circuit, such as a field-programmable gate array (FPGA) or an application-specific integrated circuit (ASIC), and the device may also be implemented as a dedicated logic circuit.

A computer suitable for executing computer programs includes, for example, a general-purpose and/or special-purpose microprocessor, or any other types of central processing units. Generally, the central processing unit receives instructions and data from a read-only memory and/or a random access memory. The basic components of the computer may include a central processing unit for implementing or executing instructions and one or more storage devices for storing instructions and data. Generally, the computer may also include one or more mass storage devices for storing data, such as a magnetic disk, a magneto-optical disk, or an optical disk, or the computer may be operatively coupled to the mass storage device to receive data from or send data to it, or both situations may exist. However, the computer may not have to have such apparatuses. In addition, the computer may be embedded in another apparatus, such as a mobile phone, a personal digital assistant (PDA), a mobile audio or video player, a game console, a global positioning system (GPS) receiver, or a portable storage device with a universal serial bus (USB) flash drive.

The computer-readable medium suitable for storing the computer program instructions and data may include all forms of non-volatile memory, media, and storage devices, including, for example, a semiconductor memory device (such as erasable programmable read-only memory (EPROM), electrically erasable programmable read-only memory (EEPROM), and flash memory devices), a magnetic disk (such as an internal hard disk or a removable disk), a magneto-optical disk, a CD ROM, and a DVD-ROM disk. The processor and the storage device may be supplemented by or incorporated into a dedicated logic circuit.

Although this specification includes many specific implementation details, which should not be considered a limitation of the scope of any disclosure or the scope of the claimed protection, but are mainly used to describe the features of specific embodiments of the present disclosure. Certain features described in embodiments of the specification may also be implemented in combination in an embodiment. On another hand, various features described in a single embodiment may also be implemented in multiple embodiments separately or in any suitable sub-combination. In addition, although features may work in certain combinations as described above and even initially claimed as such, one or more features from the claimed combination may in some cases be removed from the combination, and the claimed combination may be directed to a sub-combination or a variation of the sub-combination.

Similarly, although operations are described in a specific order in the accompanying drawings, which should not be understood that the operations are required to be performed in the specific order shown or sequentially, or requiring all illustrated operations to be performed to achieve the desired result. In some cases, multitasking and parallel processing may be beneficial. In addition, the separation of various system modules and components of embodiments of the present disclosure should not be understood that such separation is required in all embodiments, and the described program components and systems may usually be integrated together in a single software product, or packaged into multiple software products.

Thus, specific embodiments of the subject matter have been described. Other embodiments are within the scope of the claims. In some cases, the actions described in the claims may be performed in a different order and still achieve the desired result. In addition, the processes described in the accompanying drawings are not necessarily in the specific order or sequential order shown to achieve the desired result. In some embodiments, multitasking and parallel processing may be beneficial.

Only some embodiments of the present disclosure are described and they are not intended to limit the present disclosure. Any modification, equivalent replacement, improvement, etc. made within the spirit and principle of the present disclosure shall be within the scope of the present disclosure.

What is claimed is:

1. An image depth estimation method comprising:
detecting a weak texture area of a target image;
calculating depths of feature points of the weak texture area according to:
coordinates of the feature points of the weak texture area in the target image and in a reference image, and
a camera attitude change of one or more camera devices between capturing the target image and capturing the reference image;
performing fitting based on the feature points to obtain a depth plane; and
calculating depths of pixel points of the weak texture area based on the depth plane.

2. The method of claim 1, wherein performing fitting based on the feature points to obtain the depth plane includes:
determining a fitted plane according to the feature points;
calculating color deviations and/or distances between the feature points and a predetermined point of the fitted plane; and
in response to the color deviations and/or distances satisfying a predetermined condition, determining the fitted plane as the depth plane.

3. The method of claim 2, wherein determining the fitted plane includes:
calculating 3D information of the feature points according to pixel coordinates of the feature points and the depths of the feature points; and
determining the fitted plane based on the 3D information.

4. The method of claim 2, wherein determining the fitted plane as the depth plane in response to the color deviations and/or distances satisfying the predetermined condition includes:
calculating a weighted sum of the color deviations and/or distances; and
in response to the weighted sum being smaller than or equal to a predetermined value, determining the fitted plane as the depth plane.

5. The method of claim 4, wherein determining the fitted plane as the depth plane in response to the color deviations and/or distances satisfying the predetermined condition further includes:
in response to the weighted sum being greater than the predetermined value, dividing the weak texture area into sub-areas and performing fitting for the sub-areas to obtain depth planes of the sub-areas.

6. The method of claim 1, wherein performing fitting based on the feature points to obtain the depth plane includes:
filtering out abnormal points from the feature points using random sample consensus (RANSAC) algorithm to obtain reliable points among the feature points; and
performing fitting based on the reliable points to obtain the depth plane.

7. The method of claim 1, further comprising:
verifying depth calculation result by performing pixel matching on the target image and the reference image, including:
mapping a pixel point of the target image to a mapping point on the reference image according to the camera attitude change;
calculating corresponding pixel information according to the mapping point; and
comparing the corresponding pixel information with pixel information of the pixel point.

8. The method of claim 7, wherein mapping the pixel point to the mapping point includes:
obtaining a pixel coordinate and a depth of the pixel point;
determining a 3D coordinate of the pixel point according to the pixel coordinate, the depth, and a parameter of the one or more camera devices;
calculate a 3D coordinate of the mapping point according to the camera attitude change; and
obtaining a pixel coordinate of the mapping point according to the 3D coordinate of the mapping point and the parameter of the one or more camera devices.

9. The method of claim 7, wherein:
comparing the corresponding pixel information with the pixel information of the pixel point includes:
calculating corresponding color brightness information according to the mapping point; and
comparing the corresponding color brightness information with color brightness information of the pixel point to obtain a color brightness information deviation; and verifying the depth calculation result further includes:
in response to the color brightness information deviation being smaller than or equal to a predetermined value, determining that the depth of the pixel point satisfies a requirement.

10. The method of claim 1, wherein detecting the weak texture area includes:
determining a connected area of the target image;
extracting one or more candidate feature points of the connected area; and
in response to a number of the one or more candidate feature points being greater than or equal to a predetermined threshold, determining the connected area to be the weak texture area.

11. An image depth estimation device comprising:
a processor; and
a memory storing instructions that, when executed by the processor, cause the processor to:
detect a weak texture area of a target image;
calculate depths of feature points of the weak texture area according to:
coordinates of the feature points of the weak texture area in the target image and in a reference image, and
a camera attitude change of one or more camera devices between capturing the target image and capturing the reference image;
perform fitting based on the feature points to obtain a depth plane; and
calculate depths of pixel points of the weak texture area based on the depth plane.

12. The device of claim 11, wherein the instructions further cause the processor to:
determine a fitted plane according to the feature points;
calculate color deviations and/or distances between the feature points and a predetermined point of the fitted plane; and
in response to the color deviations and/or distances satisfying a predetermined condition, determine the fitted plane as the depth plane.

13. The device of claim 12, wherein the instructions further cause the processor to:
calculate 3D information of the feature points according to pixel coordinates of the feature points and the depths of the feature points; and
determine the fitted plane based on the 3D information.

14. The device of claim 13, wherein instructions further cause the processor to:
calculate a weighted sum of the color deviations and/or the distances; and
in response to the weighted sum being smaller than or equal to a predetermined value, determine the fitted plane as the depth plane.

15. The device of claim 14, wherein instructions further cause the processor to:
in response to the weighted sum being greater than the predetermined value, divide the weak texture area into sub-areas and perform fitting for the sub-areas to obtain depth planes of the sub-areas.

16. The device of claim 11, wherein the instructions further cause the processor to:
filter out abnormal points from the feature points using RANSAC algorithm to obtain reliable points among the feature points; and
perform fitting based on the reliable points to obtain the depth plane.

17. The device of claim 11, wherein the instructions further cause the processor to:
verify depth calculation result by performing pixel matching on the target image and the reference image;
map a pixel point of the target image to a mapping point on the reference image according to the camera attitude change;
calculate corresponding pixel information according to the mapping point; and
compare the corresponding pixel information with pixel information of the pixel point.

18. The device of claim 17, wherein the instructions further cause the processor to:
obtain a pixel coordinate and a depth of the pixel point;
determine a 3D coordinate of the pixel point according to the pixel coordinate, the depth, and a parameter of the one or more camera device;
calculate a 3D coordinate of the mapping point according to the camera attitude change; and
obtain a pixel coordinate of the mapping point according to the 3D coordinate of the mapping point and the parameter of the one or more camera devices.

19. The device of claim 17, wherein the instructions further cause the processor to:
calculate corresponding color brightness information according to the mapping points;
compare the corresponding color brightness information with color brightness information of the pixel point to obtain a color brightness information deviation; and
in response to the color brightness information deviation being smaller than or equal to a predetermined value, determine that the depth of the pixel point satisfies a requirement.

20. The device of claim 11, wherein the instructions further cause the processor to:
determine a connected area of the target image;
extract one or more candidate feature points of the connected area; and
in response to a number of the one or more candidate feature points being greater than or equal to a predetermined threshold, determining the connected area to be the weak texture area.
